(19) United States
(12) Patent Application Publication
(10) Pub. No.: US 2025/0206583 A1
(43) Pub. Date: Jun. 26, 2025

(54) EMERGENCY BRAKING DEVICE FOR A CABLE WINCH HAVING A CABLE DRUM WHICH IS ROTATABLE ABOUT AN AXIS OF ROTATION, CABLE WINCH, AND METHOD FOR OPERATING AN EMERGENCY BRAKING DEVICE

(71) Applicant: VINCORION Advanced Systems GmbH, Wedel (DE)

(72) Inventors: Thorben BARTSCH, Hamburg (DE); Markus TOEPFER, Hamburg (DE)

(73) Assignee: VINCORION Advanced Systems GmbH, Wedel (DE)

(21) Appl. No.: 18/849,920

(22) PCT Filed: Mar. 22, 2023
(86) PCT No.: PCT/EP2023/057280

§ 371 Date: Sep. 23, 2024

(30) Foreign Application Priority Data
Mar. 23, 2022 (DE) 10 2022 106 873.0

(51) Int. Cl. B66D 5/22

(52) U.S. Cl. CPC B66D 5/22

(57) ABSTRACT

An emergency braking device for a winch rotatable spool, the emergency braking device comprising a braking unit to decelerate the spool when a translational force acts on the braking unit. An engaging unit is rotatable about the rotation axis and linearly movable along the rotation axis, and configured to engage with an engaging contour of the spool in an active state of the emergency braking device. A closing unit has a thread and a connecting structure, with the closing unit and the engaging unit being connected via the connecting structure to be rotationally fixed and linearly movable along the rotation axis, and wherein the thread engages with a mating thread to effect a linear movement of the closing unit in the direction of the braking unit by the rotation transmitted from the engaging unit to the closing unit, in order to exert the translational force on the braking unit.

### PRIOR ART

The invention relates to an emergency braking device for a winch having a spool rotatable about a rotation axis, to a winch and to a method of operating an emergency braking device in accordance with the preamble of the independent claims.

In the field of rescue services, for example, winches are employed in combination with helicopters as rescue winches, which are usually comply with a “loss of HEC” requirement of WASA.

Against this background, an improved emergency braking device for a winch having a spool rotatable about a rotation axis, an improved winch and an improved method of operating an emergency braking device in accordance with the main claims are presented with the approach presented herein. Advantageous embodiments and improvements of the device defined in the independent claim are possible through the measures indicated in the dependent claims.

The approach presented here describes an emergency braking device which may be configured to decelerate a falling load, for example a person suspended by a rope, up to a standstill without additionally supplying energy. Also, jerky braking can be avoided. Thereby, a maximum force acting on the rope can be reduced, until standstill has been reached, for example. Thus, an abruptly and strongly increasing force acting on the rope can be reduced, for example.

What is presented is an emergency braking device for a winch having a spool rotatable about a rotation axis, wherein the emergency braking device comprises a braking unit configured to decelerate the spool when a translational force acts on the braking unit. The emergency braking device also comprises an engaging unit rotatable about the rotation axis and linearly movable along the rotation axis, and configured to engage with an engaging contour of the spool in an active state of the emergency braking device, in order to transmit rotation of the spool to the engaging unit, and a closing unit having a thread and a connecting structure, with the closing unit and the engaging unit being connected via the connecting structure so as to be rotationally fixed and linearly movable along the rotation axis. The thread engages with a mating thread to effect a linear movement of the closing unit in the direction of the braking unit by means of the rotation transmitted from the engaging unit to the closing unit, in order to exert the translational force on the braking unit

The emergency braking device may be referred to as a one-time brake, for example, which is activated for emergencies, for example in the event of uncontrolled roping, and thus may be safety relevant. For example, the emergency braking device may be arranged on a helicopter having a winch, for example a rescue helicopter. The winch may be configured to rope a rope so that people and additionally or alternatively objects can be raised or lowered, for example. To this end, the rope may be wound around the spool. In the inactive state of the emergency braking device, the engaging unit may be decoupled from the spool so that movement of the spool is not hindered by the emergency braking device. In the inactive state, the engaging unit may be held away from the spool using a retaining device, for example. In the active state, the engaging unit may be pushed against the engaging unit using a spring. For example, the closing unit may be screwed in the direction of the spool using the thread and the mating thread may in this way exert the translational force on the braking unit. The mating thread may be formed so as to be stationary. For example, the mating thread may be fixedly arranged on a housing of the winch or a structure. Thus, the mating thread may be decoupled from rotation of the spool, so that the spool may rotate relative to the mating thread. The braking unit may decelerate the spool using the translational force, which may thus act as a braking force. A magnitude of the translational force may advantageously correlate with torque acting on the spool, which is caused by a falling load, for example. Thus, the translational force may depend on a rotational speed of the spool, so that the translational force may in any case be sufficient to decelerate the spool. The engaging unit may advantageously engage with the engaging contour by positive locking, so that these two components may be rigidly connected to each other,

The emergency braking device may be provided for various fields of application in which rotating objects need to be slowed down to a stop (emergency stop). Thus, the spool mentioned represents any rotating part that may be slowed down by the emergency braking device.

According to an embodiment, the closing unit may comprise a retaining collar with the connecting structure and a receiving portion for receiving a spring unit, wherein the spring unit may be locked in an inactive state of the emergency braking device. The spring unit may be unlocked in the active state of the emergency braking device to push the engaging unit along the rotation axis into the engaging contour. Consequently, the connecting structure may be realised in the retaining collar, for example as a through-hole or as a recess. The receiving portion may be realised as a niche-like recess so that the spring unit fits therein. The unlocked spring unit may advantageously cause the linear movement of the engaging unit, in order to connect the engaging unit to the spool in a rotationally fixed way.

For example, in the inactive state of the emergency braking device, the engaging unit may be retained using a rope, for example a wire rope. The rope may act against a preloaded corrugated spring, which may push the engaging unit against the spool when the rope is severed.

According to an embodiment, the emergency braking device may comprise a trigger configured to unlock the spring unit. The trigger may be actuated manually by a user, for example, or in an automated way when a rotational speed of the spool is exceeded, for example. For example, the trigger may include pyrotechnics, with which a retaining device for retaining the engaging unit is destroyed. For example, a rope for retaining the engaging unit may be severed using the trigger. Advantageously, the emergency braking device may be referred to as a safety component configured to protect people.

According to an embodiment, the braking unit may include a brake disc and a brake pad, wherein the brake disc may be configured to be pushed against the brake pad by means of the translational force, in order to decelerate the spool. Advantageously, the translational force may be dependent on the rotational speed and additionally or alternatively on the falling load, which means the person suspended by the rope, so that the spool can be decelerated.

Furthermore, the closing unit may be configured to push the brake disc against the brake pad. This means that the brake disc may be pressed on the brake pad and the rotation of the spool can be decelerated and eventually stopped by means of the resulting frictional force.

According to an embodiment, the brake pad may be rigidly connected to the spool. For example, the brake pad may be formed as an annular extension of the spool.

The braking unit may comprise a brake package including the brake disc, a receptacle and a further spring unit arranged between the brake disc and the receptacle. Using the further spring unit, the spool may be prevented from jerking to a stop. Advantageously, the braking process can be made more comfortable for a person suspended by the rope, because the braking effect is mitigated by the spring unit.

According to an embodiment, the engaging unit may comprise at least one protrusion configured to engage with the engaging contour. For example, the protrusion may be referred to as a retaining element and may be formed as a tooth, for example, which may engage with the engaging contour. The engaging contour may be formed as at least one ramp. Advantageously, engagement of the engaging unit in the engaging contour may thereby be prevented when the spool moves in a rotational direction for reeling up the rope.

Furthermore, what is presented is a winch having a spool rotatable about a rotation axis and an emergency braking device of a previously mentioned variant.

The winch may advantageously be implemented for rescue helicopters, such as employed in mountains or over water. The spool may advantageously be formed to wind a rescue rope up and/or off. To this end, the spool may be arranged so as to be movable about the rotation axis.

What is also presented is a method of operating an emergency braking device of a previously mentioned variant. The method includes a step of engaging the engaging unit with the engaging contour of the spool, in order to transmit the rotation of the spool to the engaging unit, a step of transmitting the rotation from the engaging unit to the closing unit, a step of effecting the linear movement of the closing unit in the direction of the braking unit by engaging the thread with the mating thread and by means of the rotation transmitted from the engaging unit to the closing unit and a step of exerting a translational force on the braking unit by the linear movement of the closing unit, in order to decelerate the spool using the braking unit.

Advantageously, a winch for emergencies can be safeguarded by means of the method so that the spool can be decelerated and brought to a standstill using the emergency braking device in the event of uncontrolled roping, for example.

According to an embodiment, the method may include a step of unlocking the emergency braking device using a trigger, in order to make the engaging unit engage with the engaging contour. The emergency braking device may be activated by the step of unlocking, for example.

Embodiments of the approach presented here are illustrated in the figures and explained in greater detail in the subsequent description. In the figures:

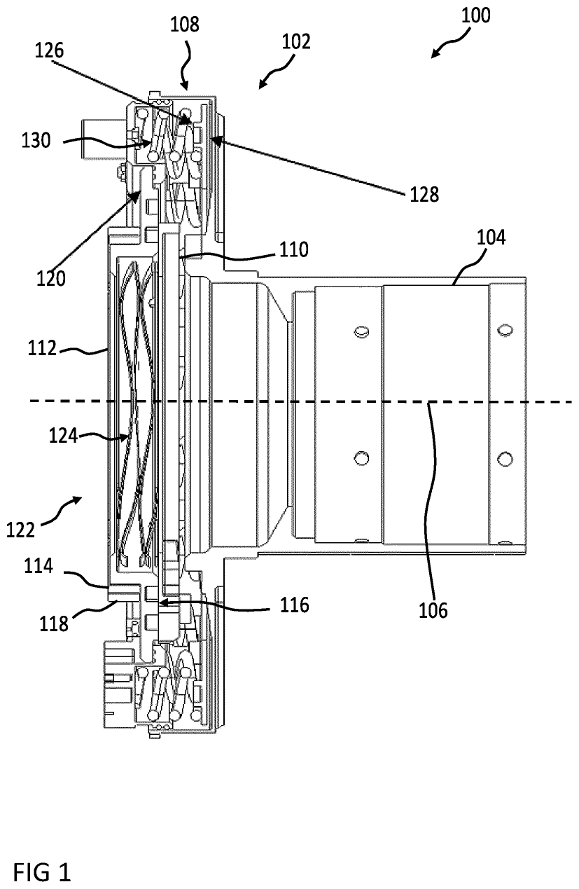

FIG. 1 is a schematic sectional view of a winch having an emergency braking device according to an embodiment;

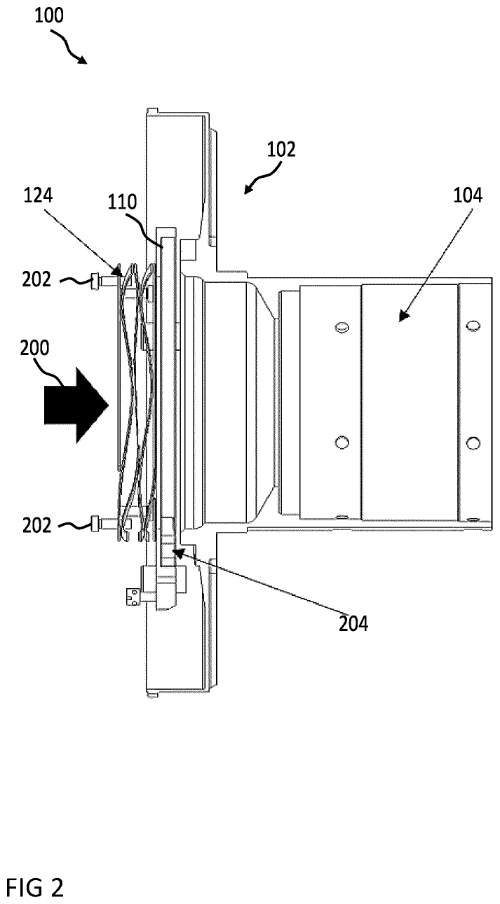

FIG. 2 is a schematic sectional view of an embodiment of a winch;

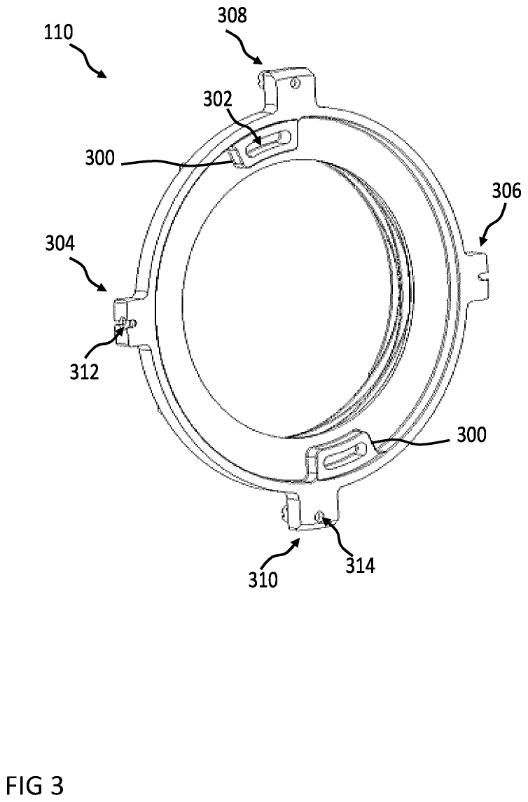

FIG. 3 is a schematic illustration of an engaging unit according to an embodiment;

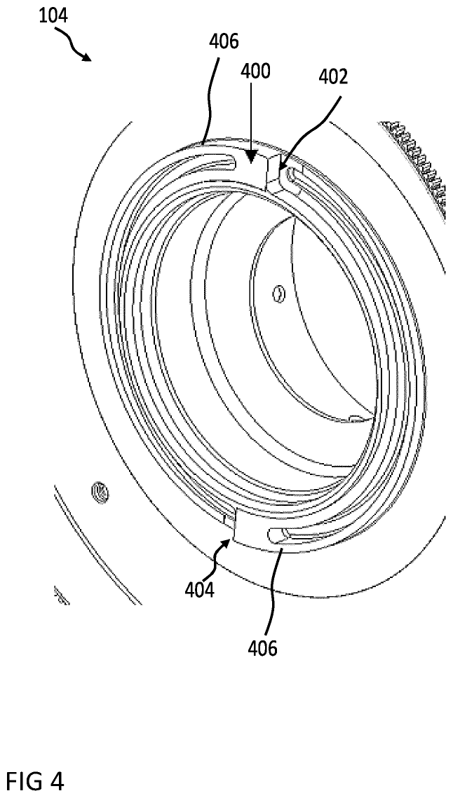

FIG. 4 is a schematic illustration of a spool having an engaging contour according to an embodiment;

FIG. 5 is a schematic sectional view of an embodiment of an arrangement of a closing unit and an engaging unit;

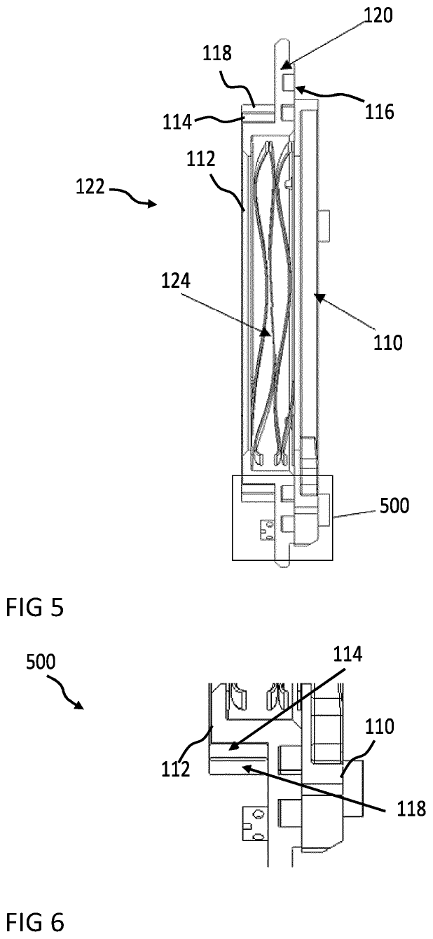

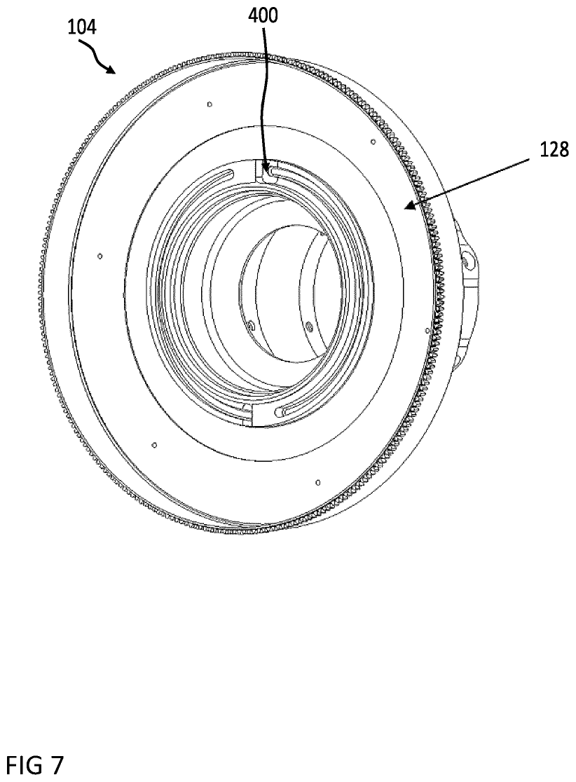

FIG. 6 is a schematic sectional view of a portion of an emergency braking device according to an embodiment;

FIG. 7 is a schematic illustration of a brake pad according to an embodiment;

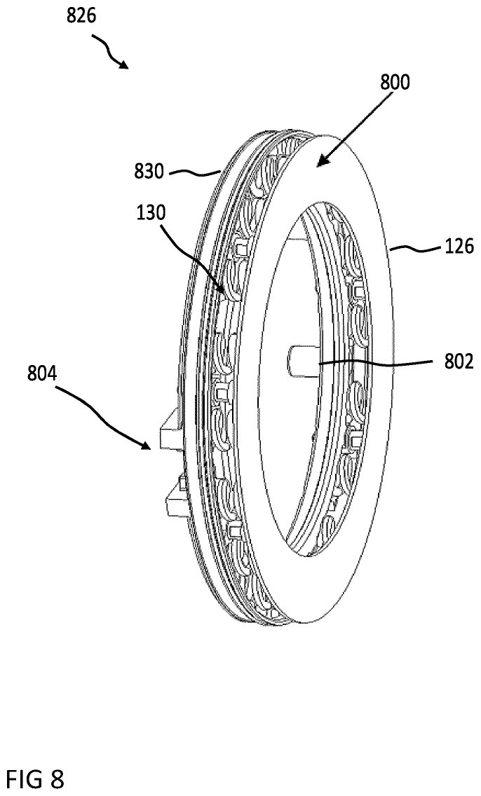

FIG. 8 is a schematic illustration of a spring-loaded brake disc according to an embodiment;

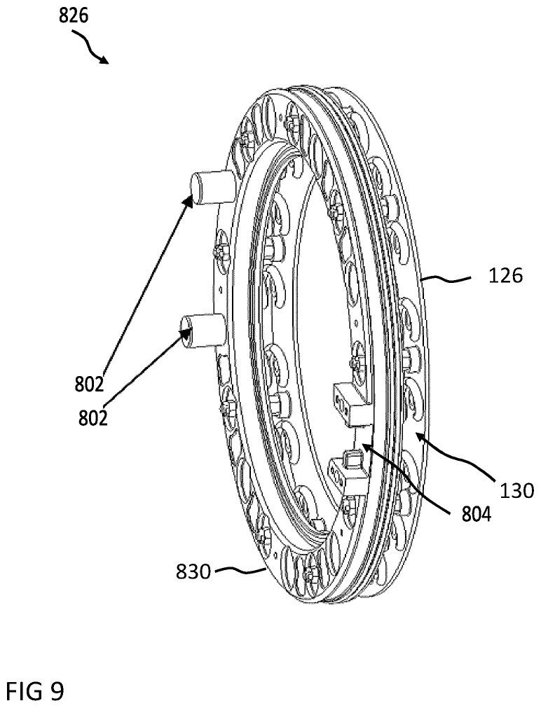

FIG. 9 is a schematic illustration of an embodiment of a spring-loaded brake disc; and

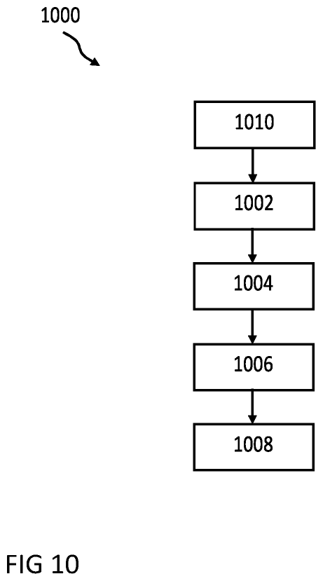

FIG. 10 is a flowchart of an embodiment of a method of operating an emergency braking device.

In the subsequent description of advantageous embodiments of the present invention, the same or similar reference numerals are used for similarly acting elements illustrated in the various figures, wherein repeated description of these elements shall be omitted.

FIG. 1 shows a schematic sectional view of a winch 100 having an emergency braking device 102 according to an embodiment. For example, the winch 100 is arranged in or on a helicopter, for example a rescue helicopter. According to this embodiment, the winch 100 is illustrated in a longitudinal section and comprises the emergency braking device 102 and a rotating part, for example in form of a spool 104. The spool is configured to wind a rope up or off, for example, and consequently is rotatable about a rotation axis 106. Even though the invention here is described with reference to a winch 100, the emergency braking device 102 may also be employed for breaking other rotating parts, for example a rotating machine component of a work machine. In such a case, the spool 104 may be understood as a portion of a shaft.

The emergency braking device 102 is also referred to as an arrestor, for example, and comprises a breaking unit 108, and engaging unit 110 and a closing unit 112. The braking unit 108 is configured to decelerate the spool 104 when a translational force acts on the braking unit 108. The braking unit 108 or at least parts thereof are arranged or arrangeable on a housing, for example. The engaging unit 110 is arranged so as to be rotatable about the rotation axis 106 and linearly movable along the rotation axis 106. The engaging unit 110 is formed to engage with an engaging contour of the spool 104 in an active state of the emergency braking device 102 also referred to as braking state, in order to transmit rotation of the spool 104 to the engaging unit 110. Furthermore, the engaging unit 110 is connected to the closing unit 112 in a rotationally fixed way and so as to be linearly movable along the rotation axis 106, which is in the direction of the spool 104. To this end, the closing unit 112 comprises a thread 114 and a connecting structure 116. The closing unit 112 is coupled to the engaging unit 110 via the connecting structure 116, which is formed as a through-hole, for example. The thread 114 engages with a stationary mating thread 118 decoupled from rotation of the spool 104. Torque transmitted from the spool 104 to the thread 114 via the engaging unit 110 consequently leads to rotation of the thread 114 in the mating thread 118. This results in a linear movement of the closing unit 112 in the direction of the spool 104 and thus in the direction of the braking unit 108, whereby the translational force can be exerted on the braking unit 108. This means that the emergency braking device 102 screws in using the thread 114 and the mating thread 118, when a load falls, for example a person suspended by a rope. The load acting as a translational force on the braking unit 108 is caught and the rotation is stopped by means of the emergency braking device 102, more specifically by means of the braking unit 108.

Advantageously, energy of a rotating part, here the spool 104, for example, is absorbed via the thread 114 and the mating thread 118 and used for decelerating the rotating part. If the thread 114 and the mating thread 118 are designed to be stiff, energy of the rotating part may already be converted to thermal energy via the thread 114 and the mating thread 118, and thereby the rotating part may already be somewhat decelerated.

According to an embodiment, the closing unit 110 comprises an annular retaining collar 120 on which the connecting structure 116 is arranged or into which it is integrated. According to an embodiment, the closing unit 112 comprises a receiving portion 122 configured to receive a spring unit 124. Furthermore, the spring unit 124 is locked in an inactive state of the emergency braking device 100 and looked in the active state of the emergency braking device 100, in order to push the engaging unit 110 along the rotation axis 106 into the engaging contour. Optionally, the emergency braking device 100 comprises a trigger configured to unlock the spring unit 124. For example, the trigger is actuated manually by a user or automatically when the rotation speed of the spool 104 is exceeded, for example. For example, the trigger comprises pyrotechnics used to release the preloaded engaging unit 110. Following the release of the engaging unit 110, unwanted unreeling of the rope from the spool 104 can be prevented reliably using the emergency braking device 102.

According to an embodiment, the braking unit 108 comprises a brake disc 126 and a brake pad 128. The brake disc 126 is formed to act on the brake pad 128 using the translational force. In other words, the brake disc 126 is pressed on the brake pad 128, and the resulting frictional force leads to deceleration of the rotation of the spool 104. According to this embodiment, the closing unit 112 is formed to press the brake disc 126 onto the brake pad 128. For example, this is done by means of a junction of the closing unit 112 and the braking unit 108 in the region of the retaining collar 120. According to this embodiment, the braking unit 108 as a whole is formed to be annular. According to an embodiment, the brake disc 126 is decoupled from the rotation of the spool 104, and thus does not rotate with the spool 104. However, the brake pad 128 is rigidly coupled to the spool 104 and correspondingly rotates with the spool 104. According to an embodiment, the brake disc is coupled to a further spring unit 130 configured so as to at least partially counteract the translational force, in order to prevent the spool 104 from jerking to a stop. Instead, comparably gentle deceleration is effected using the further spring unit 130 so that the rope and the person are treated with care in the braking process, for example. In other words, the spring force acts against the translational force.

According to an embodiment, the emergency braking device 102 is configured as an arrestor, which means as an emergency brake, without energy storage. The emergency braking device 102 is configured to stop the spool 104 when the rope is running out in an uncontrolled way.

Optionally, the spool 104 is realised as a direct winder or as a capstan, for example, and is stopped by means of the emergency braking device 102. Utilisation of the rotational energy of the spool 104 and of the following load results in generation of the corresponding braking pressure, described as translational force here, up to a standstill or halt.

In other words, it is a brake utilising the energy of the rotating spool 104, in order to close by means of the thread 114. Friction locking is effected by the energy of the rotating spool 104 and the following load and consequently is sufficient to make the spool 104 and thus also the following load come to a standstill. The brake is configured as a one-time brake. It cannot be opened easily, so that it is realised or realisable as a safety element.

The engaging unit 110, which is spring-loaded according to an embodiment, is made to engage with the engaging structure and released using a trigger, for example. With this, the rotation is taken up. The engaging unit 110 now transmits the rotation to the closing unit 112, wherein engaging unit 110 and closing unit 112 are connected to each other in a rotationally fixed way. Since the closing unit 112 has the thread 114 on the rotation axis 106 also referred to as axis of rotation and the mating thread 118 is stationary with respect to the rotation of the closing unit 112, this rotation leads to translation of the closing unit 112.

The translation pushes the rotationally free brake disc 126, which is spring-loaded so as to not let the braking force increase too strongly to suddenly, against the brake pad 128 on the spool 104. The further the spool 104 rotates, the greater the compression force becomes between the brake surfaces, which are described as the brake disc 126 and the brake pad 128 here. Friction locking between brake disc 126 and brake pad 128 leads to the standstill of the spool 104.

FIG. 2 shows a schematic sectional view of an embodiment of a winch 100. The winch 100 illustrated in FIG. 2 at least partially comprises the emergency braking device 102, wherein the winch 100, and thus also the emergency braking device, is at least similar to the winch 100 described in FIG. 1. According to this embodiment, the emergency braking device 102 is illustrated without the previously described closing unit. Instead, according to this embodiment, an effective direction of the direction of movement 200 of the engaging unit 110 in the direction of the spool 104 is illustrated symbolically. According to this embodiment, also fastening elements 202, for example screws or rivets, configured to fasten the closing unit to the spring unit 124, for example, are illustrated. For example, the spring unit 124 is formed as a corrugated spring. Furthermore, the engaging unit 110 comprises a stabilising structure 204 by which the engaging unit 110 is stabilised in its position, for example.

FIG. 3 shows a schematic illustration of an engaging unit 110 according to an embodiment. For example, the engaging unit 110 corresponds to the engaging unit 110 described in at least one of FIGS. 1 to 2. According to this embodiment, it is highlighted that the engaging unit 110 is formed to be substantially annular. According to this embodiment, the engaging unit 110 also comprises at least one protrusion 300, more specifically two protrusions 300 formed to be opposite of each other and similar. The at least one protrusion 300 is configured to engage with the engaging contour. The protrusion 300 also has an elongated through-hole 302. Furthermore, according to this embodiment, the engaging unit 110 comprises a first retaining portion 304, a second retaining portion 306 opposite the first retaining portion 304, a third retaining portion 308 arranged between the first retaining portion 304 and the second retaining portion 306, and a fourth retaining portion 310 opposite the third retaining portion 308. Optionally, the first retaining portion 304 and the second retaining portion 306 are formed to be similar. Optionally, the third retaining portion 308 and the fourth retaining portion 310 are also formed to be similar. According to this embodiment, the first and second retaining portions 304, 306 comprise an engagement opening 312 each. On the other hand, the third and fourth retaining portions 308, 310 comprise a receiving opening 314 each, which is formed to slide or screw in a fixing element, for example.

FIG. 4 shows a schematic illustration of a spool 104 having an engaging contour 400 according to an embodiment. The spool 104 illustrated here corresponds to the spool 104 described in one of FIGS. 1 to 2, for example. For example, the engaging contour 400 is formed so that the protrusions of the engaging unit, as described in FIG. 3, for example, engage therewith. For example, the engaging contour 400 functions as a rail in which the engaging unit rotates by a maximum of 180° until meeting a stopping edge 402 of the engaging contour 400. Optionally, the engaging contour 400 and additionally comprises a further stopping edge 404 arranged opposite the stopping edge 402. In the region of the stopping edge 402, the engaging contour 400 is formed to be step-like and drops off from there until meeting the further stopping edge 404. The further stopping edge 404 bus is realised in an analogue way to the stopping edge 402 so that the further stopping edge 404 is also formed to be step-like. Viewed as a whole, a number of stopping edges 402, 404 on the engaging contour 400 equals a number of protrusions on the engaging unit.

According to an embodiment, the engaging contour 400 is formed to be ramp-like. For example, the engaging contour 400 forms at least one, here two ramps 406. The ramp-like shape of the engaging contour allows for continuous rotation of the spool 104 in a direction of rotation, even when the engaging unit engages with the spool 104. This enables rotation of the spool 104 for reeling in the rope even when the emergency braking device is activated. However, rotation of the spool 104 in the opposite direction of rotation is inhibited very quickly by the engagement of the engaging unit and the activation of the braking unit resulting therefrom.

FIG. 5 shows a schematic sectional view of an embodiment of an arrangement of a closing unit 112 and an engaging unit 110. For example, the engaging unit 110 corresponds to the engaging unit 110 described in one of FIGS. 1 to 3, and the closing unit 112 corresponds to the closing unit 112 described in FIG. 1, for example. The spring unit 124, by which the engaging unit 110 is pushed into the engaging contour of the spool, also is arranged in the receiving portion 122 of the closing unit 112 here. The engaging unit 110 and the closing unit 112 also are connected to each other via the retaining collar 120 here, which has the connecting structure 116. The thread 114, which engages with the mating thread 118, is also arranged on the closing unit 112 here. According to this embodiment, a portion 500 described in greater detail in the subsequent figure is marked.

FIG. 6 shows a schematic sectional view of a portion 500 of an emergency braking device according to an embodiment. The portion 500 is shown in largest and corresponds to the portion 500 mentioned in FIG. 5, for example. Thus, the portion 500 corresponds to a contact region in which the engaging unit 110 contacts the closing unit 112 and the closing unit 112 contacts the thread 114. Furthermore, the thread 114 is arranged so that it may interact with the mating thread 118 and consequently engages with the mating thread 118. The threat 114 is rotating temporarily by means of engagement of the engaging unit in the spool starting from activation of the emergency braking device up to a standstill of the spool. The mating thread 118 is fixed, however, which means stationary with respect to the rotation of the spool, in particular. This allows for a screwing motion of the closing unit 112 and/or the engaging unit 110, in order to stop the rotation of the spool using the braking unit, as described in FIG. 1, for example.

FIG. 7 shows a schematic illustration of a brake pad 128 according to an embodiment. According to this embodiment, the brake pad 128 is arranged on the spool 104, which is formed to be at least partially hollow according to an embodiment. According to this embodiment, the brake pad 128 is arranged around the engaging contour 400 in an annular way. This means that the brake pad 128 has a greater diameter than the engaging structure for hundred. For example, spool 104 and brake pad 128 are integrally formed. Alternatively, the brake pad 128 is mounted to the spool 104.

FIG. 8 shows a schematic illustration of a brake package 826 with a spring-loaded brake disc 126 according to an embodiment. The brake disc 126 corresponds to the brake disc 126 described in FIG. 1, for example. According to this embodiment, the further spring unit 130 is configured as part of the brake package 826 between a receptacle 830 and the brake disc 126. More specifically, the further spring unit 130 is arranged on a rear side of a brake surface 800 of the brake disc 126, which is pressed onto the brake pad shown in FIG. 7 in a braking process. On the rear side, for example, the brake disc 126 comprises at least one, here two retaining elements on the receptacle 830, which are realised differently. According to this embodiment, first retaining element 802 of the retaining elements is formed to be pin-like, and a second retaining element 804 of the retaining elements is formed as a receptacle so that rotation of the brake package 826, and thus of the brake disc 126, is prevented, for example. The brake disc 126 and the receptacle 830 are formed to be annular according to this embodiment. According to an embodiment, the spring unit 130 comprises a plurality of springs arranged in a distributed way between the receptacle 830 and the brake disc 126. For example, coil springs are used as springs.

The receptacle 830 and the brake disc 126 are coupled to each other via the spring unit 130 on the one hand and via a plurality of bolts on the other hand, which cause rotational fixing. For example, the bolts are mounted to the brake disc 126, and free ends of the bolts are received by receiving contours of the receptacle 830.

When the closing unit is moved translationally due to the relative movement between thread and mating thread, as described, the closing unit exerts the activation force on the receptacle 830 and shifts the receptacle 830, and thus the entire brake package 826, in the direction of the spool, according to an embodiment. Once the brake disc 126 contacts the spool, at first the springs of the spring unit 130 are compressed when the receptacle 830 moles further in the direction of the spool. This makes the breaking torque exerted on the spool via the brake disc 126 increase slowly at first. By means of suitable design of the spring unit 130, which may also be referred to as a spring package, it can be controlled how quickly the braking action of the emergency braking device increases.

FIG. 9 shows a schematic illustration of an embodiment of a spring-loaded brake disc 126. The brake disc 126 at least resembles the brake disc 126 described in FIG. 8 and is only shown from the rear side here. According to this embodiment, the receptacle 830 optional also comprises the retaining elements 802, 804. According to this embodiment, the brake disc 126 only comprises two first retaining elements 802 spaced apart from each other and formed to be pin-like and the second retaining element 804. The retaining elements 802, 804 are formed to be translationally free as rotation-inhibiting elements.

FIG. 10 shows a flowchart of an embodiment of a method 1000 of operating an emergency braking device. For example, the method 1000 is executed for an emergency braking device as described in at least one of the FIGS. 1 to 2, for example. The method 1000 includes a step 1002 of engaging, a step 1004 of transmitting, a step 1006 of effecting and a step 1008 of exerting. In the step 1002 of engaging, engagement of the engaging unit with the engaging contour of the spool is caused, in order to transmit the rotation of the spool to the engaging unit. In the step 1004 of transmitting, the rotation from the engaging unit is transmitted to the closing unit. In the step 1006 of effecting, the linear movement of the closing unit in the direction of the braking unit is effected by engaging the thread with the mating thread and by means of the rotation transmitted from the engaging unit to the closing unit. In the step 1008 of exerting, a translational force is exerted on the braking unit by the linear movement of the closing unit, in order to decelerate the spool using the braking unit.

Optionally, the method 1000 also comprises a step 1010 of unlocking the emergency braking device using a trigger prior to the step 1002 of engaging, in order to cause the engagement of the engaging unit with the engaging contour. Doing this, a rope for holding back the engaging unit is severed, for example. Subsequently, the engaging unit is moved in the direction of the spool driven by a preloaded spring, for example, so as to be able to engage with the spool.

1. An emergency braking device for a winch having a spool rotatable about a rotation axis, the emergency braking device comprising:
a braking unit configured to decelerate the spool when a translational force acts on the braking unit;
an engaging unit rotatable about the rotation axis and linearly movable along the rotation axis, and configured to engage with an engaging contour of the spool in an active state of the emergency braking device, in order to transmit rotation of the spool to the engaging unit; and
a closing unit having a thread and a connecting structure, with the closing unit and the engaging unit being connected via the connecting structure so as to be rotationally fixed and linearly movable along the rotation axis, and wherein the thread engages with a mating thread to effect a linear movement of the closing unit in the direction of the braking unit by means of the rotation transmitted from the engaging unit to the closing unit, in order to exert the translational force on the braking unit.

2. The emergency braking device according to claim 1, wherein the closing unit comprises a retaining collar with the connecting structure and a receiving portion for receiving a spring unit, wherein the spring unit is locked in an inactive state of the emergency braking device, and wherein the spring unit is unlocked in the active state of the emergency braking device to push the engaging unit along the rotation axis into the engaging contour.

3. The emergency braking device according to claim 2, comprising a trigger configured to unlock the spring unit.

4. The emergency braking device according to claim 1, wherein the braking unit includes a brake disc and a brake pad, wherein the brake disc is pushed against the brake pad using the translational force, in order to decelerate the spool.

5. The emergency braking device according to claim 4, wherein the brake pad is rigidly connected to the spool.

6. The emergency braking device according to claim 4, wherein the braking unit comprises a brake package including the brake disc, a receptacle and a further spring unit arranged between the brake disc and the receptacle for preventing the spool from jerking to a stop.

7. The emergency braking device according to claim 1, wherein the engaging unit comprises at least one protrusion configured to engage with the engaging contour, wherein the engaging contour forms at least one ramp.

8. A winch, comprising:
an emergency braking device according to claim 1; and the spool, which is rotatable about the rotation axis.

9. A method of operating an emergency braking device according to claim 1, the method comprising the steps of:
engaging the engaging unit with the engaging contour of the spool, in order to transmit the rotation of the spool to the engaging unit;
transmitting the rotation from the engaging unit to the closing unit;
effecting the linear movement of the closing unit in the direction of the braking unit by engaging the thread with the mating thread and by means of the rotation transmitted from the engaging unit to the closing unit; and
exerting a translational force on the braking unit by the linear movement of the closing unit, in order to decelerate the spool using the braking unit.

10. A method according to claim 9, comprising a step of unlocking the emergency braking device, in order to make the engaging unit engage with the engaging contour.
